(19) United States
(12) Patent Application Publication
(10) Pub. No.: US 2020/0237585 A1
(43) Pub. Date: Jul. 30, 2020

(54) WHEEL SYSTEM FOR THE PRECISION TRANSPORT VEHICLES

(71) Applicant: Nurettin ALTINORS, Izmir (TR)

(72) Inventor: Nurettin ALTINORS, Izmir (TR)

(21) Appl. No.: 16/652,556

(22) PCT Filed: Oct. 13, 2017
(86) PCT No.: PCT/TR2017/050497

§ 371 Date: Mar. 31, 2020

(51) Int. Cl. A61G 1/02; A61G 1/04

(52) U.S. Cl. CPC A61G 1/0293; F16F 1/128; A61G 1/0212; A61G 1/04

(57) ABSTRACT

A shock absorber wheel system for absorbing vibrations and impacts on precision transport and the translocation vehicles like patient stretchers, new born baby units, portable medical devices in the health sector has a track wheel, a compressive spiral spring absorbing the vibrations and the impacts, an upper spring holder which is connected to the spiral spring and has a spindle at one end and a centering housing at the other end, a lower spring holder which is connected to the spiral spring and has a housing providing connection to the track wheel at one end and has a centering spindle connected to said centering housing.

### TECHNICAL FIELD

The invention is related with the wheel system that provides the vibration and the impulse absorbtion on the devices like patient handling stretchers, new born baby units, portable medical devices which are in the requirement of translocation and transportation.

The invention is specially relevant to the wheel system including the shock absorber which amortizes the vibrations and the impacts, in small dimensions and totally closed structure providing protection against the external effects like dust and the objects and operating in the same axis with the carrier wheel.

### PRIOR ART

Such steps which might cause danger and aggravates the conditions on the devices in need of precision carriage like patient handling stretchers, new born baby units and medical devices should be avoided. For instance, it is of vital importance to protect the patients in fracture and internal hemorrhaging cases during the patient transfer. So the patient handling stretchers should be in the speciality of carrying the patients in healthy way.

At the present time there are transport vehicles including the mechanical, electrical and the pneumatic systems. However, such devices have the difficulties in giving the loud noise, running under low weights and motion control. The wheels of the carriage devices running under the prior art are directly mounted on the system and can not absorb the vibrations coming from the ground in the direction of the spindle.

There is a utility model application with the number of TR2009/03457 and in the name of “ Shock Absorber Hydrolic Stretcher Platform” in the literature. In the abstract of the application it is stated that “The invention is a shock absorber stretcher platform produced to protect the injured/patient against the vibration coming from the speed and road conditions during the transport from one point to another and to stabilize the patient/injured in the ambulance comprising a surface, an upper chassis and a middle chassis at the top and a lower chassis at the bottom characterised in further comprising an uniaxial support chassis structured on the lower chassis moving via hydrolic pistons between the middle and the lower chassis and U arms connected to the connection spindles formed at different points on the support chassis.” As it is understood from the abstract part of the application, a structure including the hydrolic pistons, support chassis and the connection spindles is mentioned.

Another sample in the literature with the application number TR2002/01311 is a utility model application under the name of “ Shock Absorber Wheel for the Transport Vehicles”. In the abstract part of the application it is remarked that “The invention is related with the shock absorber wheel which absorb the vibrations consisting of the movements of the transport vehicles like trolleys, stretchers etc. on the rugged and rough areas and consequently damage the carried material. The shock absorber wheel according to the invention characterised in comprising a movable leg conveying the forces which the wheel is exposed to and at least one spring absorbing the forces by vibrating between the movable leg and the nippers leg. The shock absorber wheel according to the invention can have a fixed or rotating nippers.” As is seen, the system is related with the usage of the shock absorber wheel on the transport vehicles and besides it has the following disadvantages:
The spring used in the structure is the angled oncotic spring and never becomes a closed system and hence the dust and the objects in the environment might get into the spring and create danger.
As the shock absorber wheel comprising the panel, connection flap, plastic chute is in angled structure and it has the extra risk of crashing the surrounding objects during the rotational motion.

Because of the risks, the system is not suitable for the health sector which needs sensitive approaches.

As a result, new developments and the structurings are essential to eliminate the above mentioned disadvantages and to give the solutions for the wheel systems used for the precision transport vehicles.

### OBJECTIVE OF THE INVENTION

The invention is relevant to the wheel system for the precision transport vehicles eliminating all above said disadvantages and on the other fulfilling the all above requirements and giving some more additional advantages

The main purpose of the invention is to reveal the shock absorber wheel system for absorbing the vibrations and the impacts on the vehicles used for the precision transport and the translocation in health sector.

The other object of the invention is to implement the absorbtion of the vibrations sourcing from the loading or coming from ground along the way of transport, in the direction of the same axis on which the wheel spindle and the shock absorber system is mounted.

Another object of the invention is to provide a completely closed protective system to the external dust and the objects that might stuck between the spring.

The other purpose of the invention is to eliminate the risk of crashing during the rotational movement and to provide the safe transport by tiny structure which is in the same size of diameter with the wheel handling arm.

The other purpose of the invention is that; as the system has the same connection figure with the wheel, it is easily demountable on the new produced and even on the existing transport vehicles without requiring any mountage materials.

As it is seen more clearly in the following detailed explanations, the present invention is developed to implement the mentioned advantages above for the shock absorber wheel system that aims to absorb the vibrations and the impacts on the vehicles that needs precision transport like patient stretchers, new born baby units, portable medical devices. Said shock absorber wheel system comprising a track wheel, a compressive spiral spring absorbing the vibrations and the impacts, an upper spring holder which is connected to said spiral spring and has a spindle at one end and a centering housing at the other end, a lower spring holder which is connected to said spiral spring and has a housing providing connection to the track wheel at one end and has a centering spindle connected to said centering housing.

The structural and the characteristic specifications and the whole advantages of the invention will be clearly understood with the following figures and the explanations. So the evaluation should be done by considering the figures and the related explanations.

### BRIEF DESCRIPTION OF THE FIGURES

FIG. 1 is the front view of the mounted wheel system for the precision transport vehicles according to the invention.

FIG. 2 is the cross-sectional view of the mounted wheel system for the precision transport vehicles according to the invention.

FIG. 3 is the front view of the disassembled wheel system for the precision transport vehicles according to the invention.

FIG. 4 is the front view of the upper spring holder in the wheel system for the precision transport vehicles according to the invention.

FIG. 5 is the top view of the upper spring holder in the wheel system for the precision transport vehicles according to the invention.

FIG. 6 is the cross-sectional front view of the upper spring holder in the wheel system for the precision transport vehicles according to the invention.

FIG. 7 is the front view of the lower spring holder in the wheel system for the precision transport vehicles according to the invention.

FIG. 8 is the top view of the lower spring holder in the wheel system for the precision transport vehicles according to the invention.

FIG. 9 is the cross-sectional front view of the lower spring holder in the wheel system for the precision transport vehicles according to the invention.

FIG. 10 is the front view of the upper protection cover in the wheel system for the precision transport vehicles according to the invention.

FIG. 11 is the top view of the upper protection cover in the wheel system for the precision transport vehicles according to the invention.

FIG. 12 is the front view of the lower protection cover in the wheel system for the precision transport vehicles according to the invention.

FIG. 13 is the top view of the lower protection cover in the wheel system for the precision transport vehicles according to the invention.

### REFERENCE NUMBERS

100. Wheel System

10. Spiral Spring

20. Upper Spring Holder

21. Centering Housing

22. Spindle

30. Lower Spring Holder

31. Centering Spindle

32. Housing

40. Upper Protection Cover

50. Lower Protection Cover

60. Protection Cover Retainer Ring

70. Connection Unit

80. Connection Back up unit

90. Track Wheel

### DETAILED EXPLANATION OF THE INVENTION

The detailed explanation clarifies the preferred embodiment of the wheel system (100) according to the invention, in the way of more comprehensible and eliminating the restrictive effects.

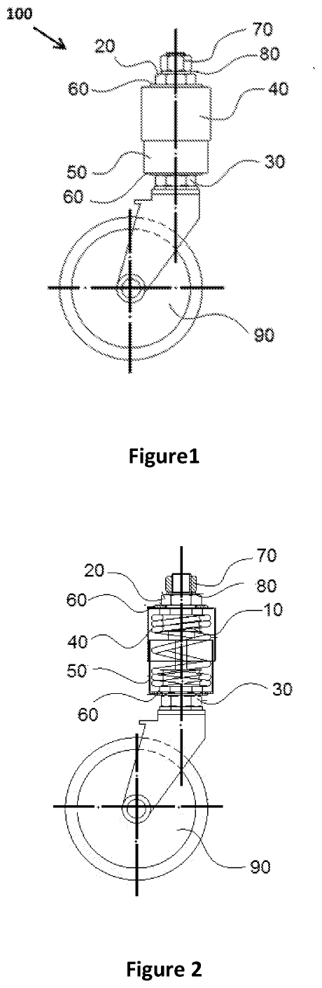

FIG. 1 shows the front view of the mounted wheel system for the precision transport vehicles (100) according to the invention. The invention is related with the shock absorber wheel system (100) absorbing the vibrations and the impacts on the precision transport and the translocation vehicles like patient stretchers, new born baby units, portable medical devices in health sector.

FIG. 2 shows the cross-sectional view of the mounted wheel system (100) for the precision transport vehicles according to the invention. As seen in the figure, the shock absorber wheel system (100) comprises:
a spiral spring (10), compressive spring, which is grinded and has threaded screw function at both ends,
an upper spring holder (20) providing screw connection to the spiral spring (10) via threaded outer surface, with a spindle (22) at one end and a centering housing (21) at the other end,
a lower spring holder (30) providing screw connection to the spiral spring (10) via threaded outer surface, with a threaded structured housing (32) at one end and a centering spindle (31) at the other end,
an upper protection cover (40) surrounding the spiral spring (10) and produced by the sheet material,
a lower protection cover (50) surrounding the spiral spring (10) which is produced by the sheet material and which has a diameter that is able to introduces into the upper protection cover (40),
a protection cover retainer ring (60) which is a connection part fixing the upper protection cover (40) and the lower protection cover (50) to the inner parts,
a connection unit (70) connecting the shock absorber wheel (100) to the transport vehicle casing,
a connection back up unit (80) which is replaced under the connection unit (70) and compressed to prevent the loosening,
a track wheel (90) that provides the movement of the transport vehicle.

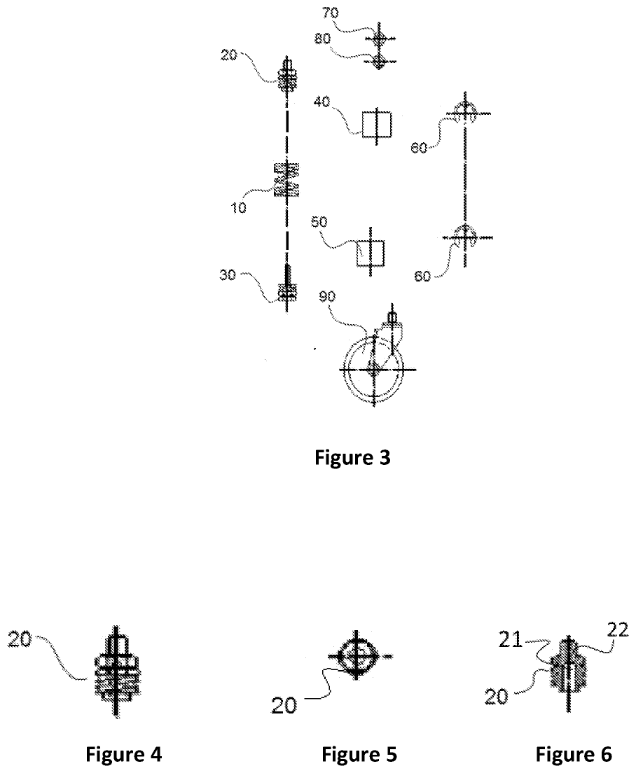

FIG. 3 is the front view of the disassembled wheel system (100) for the precision transport vehicles according to the invention. The connection of the equipments of the wheel system (100) is as follows:

The wheel system (100) is connected to the transport vehicle by the spindle (22) on the upper spring holder (20) through the connection unit (70). The connection unit (70) is preferably a mountage nut. In order to prevent the loosening, a connection back up unit (80) is placed between the connection unit (70) and upper spring holder (20) and spindle (22). The connection back up unit (80) is preferably is a lock washer.

The spiral spring (10) is a grinded compression spring and designed to absorb the vibrations and the impacts in the wheel system (100). The space between the spirals on the spiral spring (10) is narrowed at both ends to brought into a screw function. Thereby it is provided to be screwed on the surface of the upper spring holder (20) and the lower spring holder (30). The spiral spring (10) is designed to stretch up to 3 cm in case of the load of minimum 5 kg and maximum 75 kg is applied on. By means of screwing the spiral spring (10) to the upper spring holder (20) and the lower spring holder (30), it is provided for the spiral spring (10) to be in the same axis with the spring holders (20,30). Hence the system is provided to exist in a small dimension and simple structure.

There is a centering spindle (31) on the lower spring holder (30) and a centering housing (21) on the upper spring holder (20). By introducing the centering spindle (31) on the lower spring holder (30) into the centering housing (21) on the upper spring holder (20), spring (10) axis is immobilised and bending is prevented. FIGS. 4,5 and 6 shows the different point of view of the upper spring holder (20) in the wheel system (100) for the precision transport vehicles according to the invention.

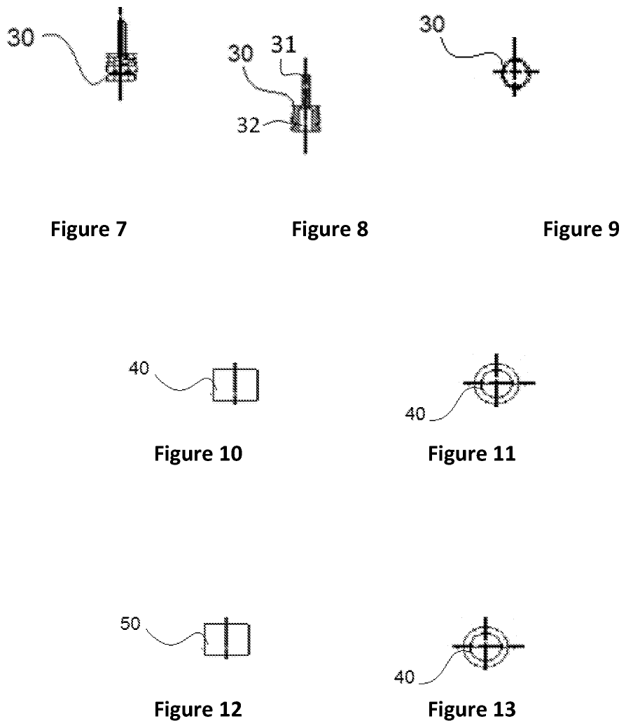

FIGS. 7, 8 and 9 shows the different point of view of the lower spring holder (30) in the wheel system (100) for the precision transport vehicles according to the invention. The lower spring holder (30) has a threaded housing (32) at the lower surface thereof. The screw connection part on the track wheel (90) is fixed on the threaded housing (32) on the lower spring holder (30). So the spindle axis of the track wheel (90) is in the equiaxial structure with the axis of the spiral spring (10) and the spring holders (20, 30). Due to equiaxial structure, it is provided for the shock absorber wheel system (100) to be mounted on the existing standard wheel (90) vehicles without any necessity of any additional connection part.

FIGS. 10-13 shows the front and top view of the upper protection cover (40) and the lower protection cover (50) in the wheel system (100) for the precision transport vehicles according to the invention. The spiral spring (10) structure is covered by the upper protection cover (40) and the lower protection cover (50). Said upper protection cover (40) and the lower protection cover (50) are fixed to the inner parts, upper spring holder (20) and lower spring holder (30), by the help of protection cover retainer ring (60). The diameter of the lower protection cover (50) is less than the diameter of the upper protection cover (40); so these covers (40,50) are able to interlock each other. By this feature, the length of the system shrinks and extends during the stretching of the spiral spring (10). In one of the preferred embodiment of the invention, said protection covers (40, 50) are made of sheet material. By means of the covers (40, 50), also the hygiene of the wheel system (100) is maintained and the sticking of the outside objects on the spiral spring (10) is prohibited.

1. A shock absorber wheel system comprising a track wheel and absorbing the vibrations and the impacts on the precision transport and the translocation vehicles like patient stretchers, new born baby units, portable medical devices in health sector characterized in comprising:
a compressive spiral spring absorbing the vibrations and the impacts;
an upper spring holder which is connected to said spiral spring and has a spindle at one end and a centering housing at the other end; and;
a lower spring holder which is connected to said spiral spring and has a housing providing connection to the track wheel at one end and has a centering spindle connected to said centering housing.

2. The shock absorber wheel system according to claim 1, characterized in comprising;
an upper protection cover surrounding the spiral spring; and
a lower protection cover surrounding the spiral spring which has a diameter that is able to introduces into the upper protection cover.

3. The shock absorber wheel system according to claim 1, characterized in comprising a connection unit which provides the connection between said track wheel and the transport vehicle via the spindle on the upper spring holder.

4. The shock absorber wheel system according to claim 3, characterized in comprising a connection back up unit which is compressed under the connection unit and prevents loosening.

5. The shock absorber wheel system according to claim 1, characterized in that; said spiral spring has threaded screw function at both ends.

6. The shock absorber wheel system according to claim 5, characterized in that the upper spring holder having the threaded outer surface that provides screwed connection to the mentioned spiral spring.

7. The shock absorber wheel system according to claim 5, characterized in that the lower spring holder having has the threaded outer surface that provides screwed connection to the mentioned spiral spring.

8. The shock absorber wheel system according to claim 2, characterized in comprising a protection cover retainer ring which fixes the upper protection cover and the mentioned lower protection cover to the inner parts.

9. The shock absorber wheel system according to claim 2, characterized in that the upper protection cover and the lower protection cover are made of sheet material.

10. The shock absorber wheel system according to claim 1, characterized in that the spring is able to stretch maximum in 3 cm length when the load in 5-75 kg is applied.
